(19) United States
(12) Patent Application Publication
(10) Pub. No.: US 2006/0061946 A1
(43) Pub. Date: Mar. 23, 2006

(54) Monitor apparatus

(76) Inventor: John Paul Vick, Holland, MI (US)

Correspondence Address: King & Jovanovic, PLC, 170 College Avenue, SUITE 230, HOLLAND, MI, 49423, US

(21) Appl. No.: 11/214,453

(22) Filed: Aug. 29, 2005

Related U.S. Application Data
(63) Continuation-in-part of application No. 10/985,663, filed on Nov. 10, 2004, now abandoned.
(60) Provisional application No. 60/518,796, filed on Nov. 10, 2003.

(51) Int. Cl. G06F 1/16

(52) U.S. Cl. 361/681

(57) ABSTRACT

A monitor apparatus, comprising: (a) a housing having an opening; (b) a display positioned within the housing, wherein the display includes a plurality of discrete displays, each of which is visible from within the opening in the housing; (c) at least one input for each of the discrete displays, to, in turn, facilitate the connection of each of the discrete displays with a computer; and (d) a power supply to provide power to the display.

### CROSS-REFERENCE TO RELATED APPLICATIONS

This application is a continuation-in-part of co-pending U.S. application Ser. No. 10/985,663, filed on Nov. 10, 2004, entitled “MONITOR APPARATUS,” which claims the benefit of U.S. Provisional Application Ser. No. 60/518,796, filed Nov. 10, 2003, entitled “MONITOR APPARATUS,” both of which are hereby incorporated herein by reference in their entirety, including all references cited therein.

### BACKGROUND OF THE INVENTION

1. Field of the Invention

The present invention relates in general to a monitor apparatus, and more particularly, to a monitor apparatus which includes a plurality of discretely controlled displays within a single housing member.

2. Background Art

Monitor apparatuses for use with, among other applications, computers have been known in the art for many years. Inasmuch as the use of personal computers has steadily increased over the past twenty years, there has been an ever-increasing commercial demand to decrease individual component size, while increasing the operability of the device. For example, whereas computer components are becoming smaller, there has been a desire to provide more functionality (i.e., more memory in a smaller computer, a larger display without a larger housing for same, etc.).

One advancement has been that monitor sizes have increased thereby securing increased space on the desktop. To combat the increase in size, CRT monitors have been largely replaced by LCD and PLASMA monitors. The LCD/PLASMA monitors provide similar screen sizes but are generally substantially thinner than corresponding CRT monitors. While LCD monitors have returned some desk space to the user, another trend of utilizing multiple monitors further compromises space on the desktop.

Thus, it is an object of the present invention to provide a monitor that includes multiple discrete displays within a single housing, to, in turn, minimize the space on the desktop required and utilized by the monitor of a personal computer. Of course, it will be understood that such a monitor has utility beyond its use in association with personal computers.

These and other objects of the present invention will become apparent in light of the present specification, claims, and drawings.

### BRIEF DESCRIPTION OF THE DRAWINGS

The invention will now be described with reference to the drawings wherein:

FIG. 1 of the drawings is a front elevational schematic view of an embodiment of the present invention, showing, among other things, a substantially concave display having four discrete displays;

FIG. 2 of the drawings is a front elevational schematic view of an embodiment of the present invention, showing, among other things, a substantially concave display having two discrete displays;

FIG. 3 of the drawings is a front elevational schematic view of an embodiment of the present invention, showing, among other things, a substantially concave display having three discrete displays;

FIG. 4 of the drawings is a front elevational schematic view of an embodiment of the present invention, showing, among other things, a substantially concave display having six discrete displays;

FIG. 5 of the drawings is a front elevational schematic view of an embodiment of the present invention, showing, among other things, a substantially convex display having four discrete displays; and

FIG. 6 of the drawings is a front elevational schematic view of an embodiment of the present invention, showing, among other things, a substantially flat display having four discrete displays.

### DETAILED DESCRIPTION OF THE INVENTION

While this invention is susceptible of embodiment in many different forms, there is shown in the drawings and will be described herein in detail, a specific embodiment with the understanding that the present disclosure is to be considered as an exemplification of the principles of the invention and is not intended to limit the invention to the embodiment illustrated.

It will be understood that like or analogous elements and/or components, referred to herein, are identified throughout the drawings by like reference characters. In addition, it will be understood that the drawings are merely schematic representations of embodiments of the invention, and some of the components may have been distorted from their actual scale for purposes of pictorial clarity.

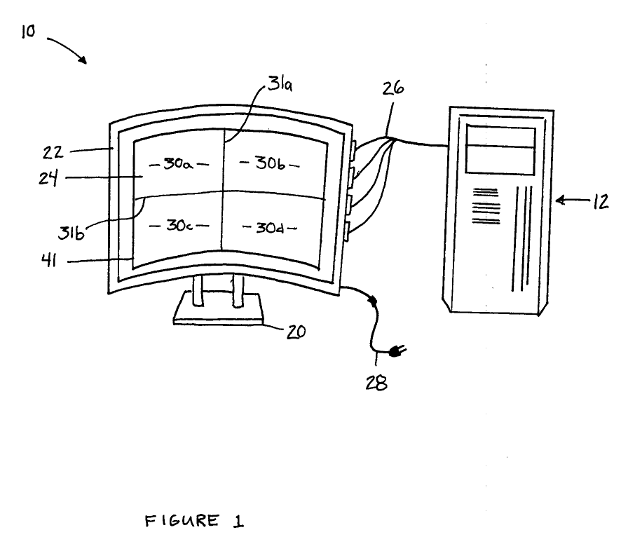

Referring now to the drawings, and to FIG. 1 in particular, monitor apparatus 10 is generally shown as being associated with computer 12. Computer 12 may comprise a computer commonly referred to as a PC, which may comprise a conventional personal computer having a keyboard, a mouse, a processor, i/o devices and/or storage. However, monitor apparatus 10 is not limited to the use of any particular device. Such a PC may be operating on any one of a number of operating systems, i.e., Windows (95, 98, SE, ME, NT, 2000, XP, etc.), MacOS (8, 9, X, etc.), or Linux, among others.

Monitor apparatus 10 is shown in more detail as comprising support 20, housing 22, display 24, computer communication 26, and power supply 28. Support 20 comprises a base and a leg member connecting the base with the leg. As such, support 20 facilitates the positioning of the display above a surface (i.e., a desk, table or otherwise), so that it is at eye level. Of course, in certain embodiments the display may be associated with a wall, wherein support 20 may be omitted entirely.

Housing 22 provides a frame or cover for the electronics and provides an aesthetically appealing surround for display 24. Typically, housing 22 comprises a plurality of panels which are interconnected and/or otherwise attached together or to the inner electronics of display 24. Preferably, such panels comprise a plastic material, while other materials are likewise contemplated for use. Housing 22 includes an opening 41 within which display 24 is positioned.

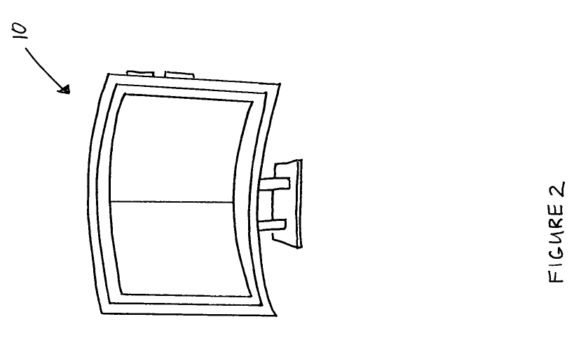

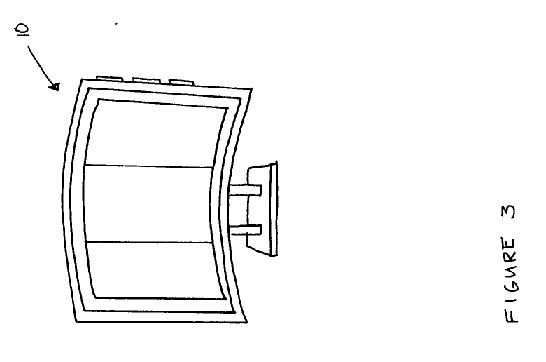

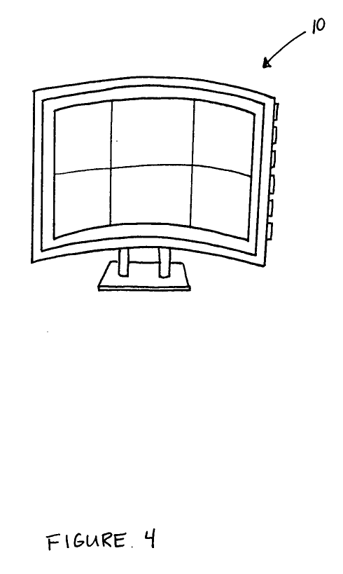

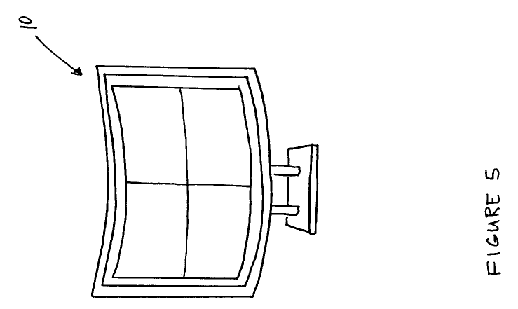

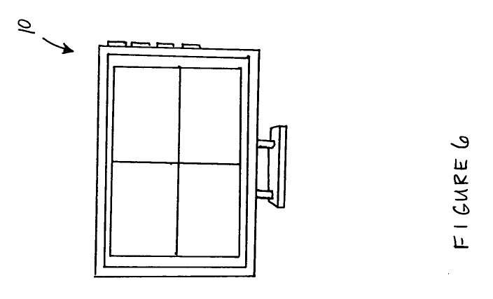

As is shown in FIG. 1, display 24 comprises a plurality of separate and discrete LCD/PLASMA displays, such as discrete displays 30a, 30b, 30c, and 30d, which are separated by division lines 31a, 31b. Typically, such a display includes a single LCD/PLASMA display, whereas the present invention comprises a plurality of discrete displays which are visible through opening 41. Of course, a greater or lesser number of discrete displays is contemplated, such as, but not limited to, two, three, or six discrete displays as can be seen in FIGS. 2, 3, and 4, respectively. It is contemplated that housing 22 and/or display 24 may be substantially horizontally concave (FIGS. 1-4), substantially horizontally convex (FIG. 5), or substantially flat (FIG. 6). Indeed, monitors comprising a substantially concave or convex configuration are the subject of United States Design Pat. Nos. D497,166 S and D501,854 S, by the same inventor, both of which are hereby incorporated herein in their entirety.

Computer communication 26 comprises a plurality of monitor connections which connect the separate discrete displays to a video card. It is contemplated that such connections may connect each of the separate and discrete displays, for example discrete displays 30a-30d in FIG. 1, to a single video card or to multiple video cards (which may be placed in one PC or which may be positioned in different PCs). Advantageously, where multiple PCs are utilized, the output from the same can be seen on a single monitor apparatus. Computer communication 26 may comprise digital or analog connections through a number of different commonly known connectors.

Power supply 28 is shown as comprising a transformer which is capable of converting line voltage (i.e. 110-240V 50-60 Hz) to a desired voltage for the display and the associated electronics. It is contemplated that the power supply may be positioned within the computer or the display or, alternatively, may comprise a separate unit commonly referred to as a “brick.”

In operation, a user can operate each of the discrete displays, such as discrete displays 30a-30d, within housing 22 as separate monitors, each capable of performing as an individual monitor. As such, the separate discrete displays can be attached to different PCs or to the same PC. Moreover, it is contemplated that the software associated with monitor 10 (i.e., the driver and support software which may be programmed by one of skill in the art) may facilitate the stretching of an image across all of the discrete displays so as to essentially mimic a single integral display. It is further contemplated that a user can toggle from one to the other.

The foregoing description merely explains and illustrates the invention and the invention is not limited thereto except insofar as the appended claims are so limited, as those skilled in the art who have the present disclosure before them will be able to make modifications without departing from the scope of the invention.

What is claimed is:

1. A monitor apparatus, comprising:
a housing having an opening;
a display positioned within the housing, wherein the display includes a plurality of discrete displays, each of which is visible from within the opening in the housing;
at least one input for each of the discrete displays, to, in turn, facilitate the connection of each of the discrete displays with a computer; and
a power supply to provide power to the display.

2. The monitor apparatus according to claim 1, wherein the display comprises a substantially flat configuration.

3. The monitor apparatus according to claim 1, wherein the display comprises a substantially horizontally concave configuration.

4. The monitor apparatus according to claim 1, wherein the display comprises a substantially horizontally convex configuration.

5. The monitor apparatus according to claim 1, wherein the plurality of discrete displays comprises two discrete displays.

6. The monitor apparatus according to claim 1, wherein the plurality of discrete displays comprises three discrete displays.

7. The monitor apparatus according to claim 1, wherein the plurality of discrete displays comprises four discrete displays.

8. The monitor apparatus according to claim 1, wherein the plurality of discrete displays comprises six discrete displays.

9. A monitor apparatus, comprising:
a housing having an opening;
a display positioned within the housing, wherein the display comprises a substantially horizontally concave configuration, and wherein the display includes a plurality of discrete displays, each of which is visible from within the opening in the housing;
at least one input for each of the discrete displays, to, in turn, facilitate the connection of each of the discrete displays with a computer; and
a power supply to provide power to the display.

10. The monitor apparatus according to claim 9, wherein the housing comprises a substantially horizontally concave configuration.

11. The monitor apparatus according to claim 9, wherein the plurality of discrete displays comprises two discrete displays.

12. The monitor apparatus according to claim 9, wherein the plurality of discrete displays comprises three discrete displays.

13. The monitor apparatus according to claim 9, wherein the plurality of discrete displays comprises four discrete displays.

14. The monitor apparatus according to claim 9, wherein the plurality of discrete displays comprises six discrete displays.

15. A monitor apparatus, comprising:
a housing having an opening;
a display positioned within the housing, wherein the display comprises a substantially convex configuration, and wherein the display includes a plurality of discrete displays, each of which is visible from within the opening in the housing;
at least one input for each of the discrete displays, to, in turn, facilitate the connection of each of the discrete displays with a computer; and
a power supply to provide power to the display.

16. The monitor apparatus according to claim 15, wherein the housing comprises a substantially horizontally convex configuration.

17. The monitor apparatus according to claim 15, wherein the plurality of discrete displays comprises two discrete displays.

18. The monitor apparatus according to claim 15, wherein the plurality of discrete displays comprises three discrete displays.

19. The monitor apparatus according to claim 15, wherein the plurality of discrete displays comprises four discrete displays.

20. The monitor apparatus according to claim 15, wherein the plurality of discrete displays comprises six discrete displays.
